(19) United States
(12) Patent Application Publication
(10) Pub. No.: US 2025/0139669 A1
(43) Pub. Date: May 1, 2025

(54) AI-ADVERTISING GENERATION

(71) Applicants: Raphael Pereymer, Brooklyn, NY (US); Arsen Pereymer, Brooklyn, NY (US)

(72) Inventors: Raphael Pereymer, Brooklyn, NY (US); Arsen Pereymer, Brooklyn, NY (US)

(21) Appl. No.: 18/934,090

(22) Filed: Oct. 31, 2024

Related U.S. Application Data
(60) Provisional application No. 63/546,650, filed on Oct. 31, 2023.

(51) Int. Cl. G06Q 30/0241; G06F 40/40; G06Q 30/0242; G06Q 30/0251; G06T 11/60

(52) U.S. Cl. CPC G06Q 30/0276; G06F 40/40; G06T 11/60; G06Q 30/0242; G06Q 30/0251

(57) ABSTRACT

A system for the production of advertisements with a system input related to a specific product. The product input includes any of a product image and product description, product image with product description and system generated questions to elicit information about the product, user input advertisement ideas and images, existing brand details, user input of a link to existing product, service or app, and user uploads photographs or other media showing product. Once the product input has been entered into the system it is processed with generation of relevant background ideas for user selection. AI is utilized to generate ads for appropriate placement on selected platforms. Commercial effectiveness is monitored, in order to constantly and consistently monitor the ads for appropriate changes and placements.

### FIELD OF THE INVENTION

This invention relates to methods for the utilization of artificial intelligence software developments (AI) for the production of targeted product advertisements and advertisement campaigns.

### BACKGROUND

Artificial Intelligence (AI) applications are currently popular in the marketing domain. AI marketers are able to deliver highly targeted and personalized ads with the help of behavioral analysis, and pattern recognition in ML, etc. Audiences are able to be re-targeted at proper times to ensure better results and reduced feelings of distrust and annoyance. AI helps with content marketing in a way that matches the brand's style and it is used to handle routine tasks like performance, campaign reports, and the like.

Chatbots powered by AI, Natural Language Processing, Natural Language Generation, and Natural Language Understanding are able to analyze the user's language and respond in the ways humans do. In addition, AI can provide users with real-time personalization, based on their behavior and can be used to edit and optimize marketing campaigns to fit a local market's needs.

Specific methods and programs for utilizing the potential of AI for advertising and marketing purposes however remain to be developed.

### SUMMARY

It is an object of the invention to provide specifically tailored methods and input for the utilization of AI in generating image and video advertisements (ads) and ad campaigns.

It is a further object to provide a process that uses an input of a product image or video to generate image or video ads for that product with the input being effected with various methods.

It is a still further object to encompass various inputting methods including input of a store website which then loads the product or video images found on that site, or by the user uploading a product or video image. The output—the generated image ads—may be in different layouts (i.e. different text positions/sizes), different styles (i.e. different ad backgrounds, different fonts, different texts, different color schemes, etc.), and/or for different products. This process may also be used to generate ad copy for the product image or video input.

Generally, the present invention comprises the use of AI, with background loaded advertisements (ads), types, videos, captions, images with and without relation to niche products and services, with texts and themes, and styles with variations in formatting for on-line presentations, with, for example, variations in sizes, shapes, fonts and the like. Relational AI is also used with respect to psychological and motivational effectiveness for various target audiences with respect to products and services.

Generally, in embodiments herein, a system for the production of advertisements comprises an input related to a specific product, whether directly from a user or from an AI system or a combination thereof. In a typical embodiment the system comprises (it is understood that “image” or “media image” encompasses both print and video images):

1) a product input comprising at least one of:
a. a product image and product description,
b. product image with product description and system generated questions to elicit information about the product,
c. user input advertisement ideas and images,
d. existing brand details,
e. user input of a link to existing product, service or app, and
f. user uploads photographs or other media showing product.

Once the product input has been entered into the system it is processed with, in embodiments, the processing steps of:

2) processing of the input with at least one of:
a. isolating and polishing an input product image and generating relevant background ideas for user selection, then using AI to insert the product into separate multiple, relevant backgrounds, with audio, video or print advertisement text, with multiple user selectable options of audio, video or print appearances and combinations, with optional relevance to a proposed platform for the advertisements;
b. generating questions relevant to an input product and using answers to target a relevant advertisement audience with appropriate features and imagery and generating multiple advertisement texts and layouts, with optional relevance to a proposed platform for the advertisements;
c. direct user entry of advertisement ideas and images with generation of advertisements with appropriate features and imagery and generating multiple advertisement texts and layouts, with optional relevance to a proposed platform for the advertisements;
d. direct user entry of brand details and ad texts with ad styles and/or settings with the system generating advertisements with brand details and selected ad styles and/or settings;
e. direct user input of internet links to product or direct entry of product details with system scraping of product page details with retrieval or product type, description and media or video images for user review and editing with user selection of stock or AI generated footage for selected addition and user selection of video setting and ad script and selected relevant additions;
f. direct user uploading of media showing a product and stock footage related to product with AI modifying the media and generating relevant footage and ad script to generate video ad editable by user;

After the product input has been processed in the manner described, with generation of ads with appropriate placement on the selected platforms, commercial effectiveness is monitored, with various embodiments, in order to constantly and consistently monitor the ads for appropriate changes and placements such as with the:

3) providing of an ad autopilot which monitors a user's linked ad account, checks key performance indicators against user-set thresholds with ads underperforming relative to the thresholds being replaced by other ads.

As used herein, AI is defined as specific programs with a “fuzzy logic” configuration enabling it to analyze and generate ads (texts, images, videos and the like) with targeted outputs based on specific input (or anticipated input) in product fields which are defined or are of general common operative design. The AI operates with a database with widespread targeted information with respect to advertisements, such as form, format and conceptual presentation; psychological effect; product history; information and marketing background and the like. In effect, the AI initially “thinks” or “conceives” of ad ideas and then turns those ad ideas, which it generated, into actual image ads in different ad types, styles, layouts and the like.

In an exemplary embodiment, AI is employed to generate ad ideas for both image ads and video ads (i.e., a prompt is sent to an AI source, to generate “n” number of ad ideas for a business/product that a user selects and/or specifies/describes.) In a second exemplary embodiment AI is used to generate image ads (i.e., a prompt is sent to an AI source to generate “n” number of image ads for a business/product that a user selects and/or specifies/describes.) Image ads are used in an embodiment by putting ad captions generated by AI onto an image ad (i.e., captions generated by an AI are then put on to an image to form an image ad with text on it). Thereafter, in another embodiment, ad ideas are generated by AI as a prompt to generate image ads, also by using AI (i.e., an idea generated by an AI is selected by a user and is then sent to an AI source as a prompt to generate image ads).

In another embodiment, AI is instructed to generate video ads (i.e., a prompt is sent to an AI source to generate “n” number of video ads for a business/product that a user selects and/or specifies/describes.) AI is used in a further embodiment to generate ad captions (i.e., a prompt is sent to an AI to generate “n” number of captions for a business/product that a user selects and/or specifies/describes).

In other embodiments, a radio button selection process is used for generating ad ideas. (i.e., a user selects a Product Niche, such as Clothing, then selects a Product Type, such as Jackets, and that input is used to generate ad ideas). Similarly, a radio Button Selection process is further used in some embodiments for generating image ads. (i.e., a user selects a Product Niche, such as Clothing, then selects a Product Type, such as Jackets, and that input is used to generate image ads).

Image ads are generated, for example, with AI using an uploaded image (i.e., a. user uploads an image of a green leather jacket product, then AI is used to turn that into an image ad). Text ads are generated with AI (i.e., for example, background is generated by AI according to a user's selection/specification for a business/product, then texts are generated by AI as well and added to the background—all collectively forming a “text” image ad).

In another embodiment of generating text ads with AI, an uploaded image is used (i.e., a user uploads an image of a green leather jacket product, then AI is used to generate headlines, descriptions, Call-To-Action text and/or other texts which is then added to the uploaded image, such as an image uploaded by the user—collectively forming a custom “text” image ad).

Examples of using AI for developing themes include choosing an ad type or “theme” (i.e., Funny, Cool, Abstract, Simple, Emotional, etc., for the selected/specified business/product).

AI is used in other embodiments to choose an image ad style (i.e., Vector, Photo, Realistic, Abstract, 3D, Pop Art, etc. for the selected/specified business/product). A user is thereby permitted to select/choose ad type or theme (i.e., a user is able to choose between a number of ad types and/or themes, such as Funny, Cool, Abstract, Simple, Emotional, etc., for an ad generated by AI). Alternatively, or in addition, a user selects/chooses an image ad style (i.e., a user is able to choose between a number of image ad styles, such as Vector, Photo, Realistic, Abstract, 3D, Pop Art, etc. . . . , for an ad generated by AI). A user is able to select/choose ad template (i.e. various image ad layouts, such as with different text placements, different image placements, different shapes, fonts, styles, colors, mood/tone, etc.). In other embodiments, a user is permitted to input a website, which is then used by AI to output ads for the products or services on that website. (i.e., a user enters a url of a store website that sells shoes, then AI uses metadata on that site, such as product photos, product descriptions, product prices, site information/text, etc., to generate multiple image ads for each product). For formatting and appearance purposes, users are enabled to generate different ad sizes, and for different platforms, such as Landscape, Square, and Vertical, as well as different size ratios, i.e., 4:3, 1:2, etc.

Other objects, features and advantages of the invention will become evident from the following discussion and drawings in which:

### SHORT DESCRIPTION OF THE DRAWINGS

FIGS. 1-3 are flow charts exemplifying the invention with operational steps with:

FIG. 1 and continuing FIG. 1A showing a product image ad flow chart with AI enhanced development and operation;

FIG. 2 depicting a similar concept image ad flow chart with AI development input; and

FIG. 3 and continuing FIG. 3A showing a similar flow chart with a video ad flow.

### DETAILED DESCRIPTION AND OF DRAWINGS

Three embodiments of ad generation: product ads, creative ads and ad builders, provide the actual AI ad generation, according to the following exemplary procedures.

In a first embodiment of a product ad, 100+ image ads are generated from an uploaded product photo. In another embodiment of a creative ad, 100+ image ads and ad ideas are generated from a description of a product, service, app or business. In a third embodiment of a generalized ad builder, 100+ image ads are generated from an ad idea/concept which is input by a user.

### Flow 1: Product Ad

In the embodiment of a product ad generation, a product image is input to the system which then takes the user-provided image and initially uses internal processing software to remove background so that only the product image is visible and the background becomes transparent. Thereafter, the system polishes the image.

The system is provided with a user uploaded product description and product input, with the system then generating background ideas and the user can select one of these background ideas, or a background preset. AI algorithm software is used to put the product image (with the transparent background) into the scene/background idea that the user selects.

The system is further configured to use an LLM (Large Language Model) AI to perform any or all of the following generating actions:
1) generating ad texts relevant to the product input typed by the user and, with the LLM generates multiple Slogan/Headline texts relevant to the product input typed by the user. These slogans/headlines are used for the generated image ads;
2) generating multiple description texts relevant to the product input typed by the user, with these descriptions being used for the generated image ads;
3) generating a CTA (call-to-action) text relevant to the product input typed by the user. Example: “Buy Now” for the generated image ads:
4) generating a review message text relevant to the product input typed by the user, along with a review name, with these texts to be used for some of the generated image ads;
5) generating multiple question texts selling the product, based on the product input typed by the user. Example: “Want to look like a rock star?” for a leather jacket. This is to be used for some of the generated image ads;
6) generating a set of “bullet points” outlining the perks of the product based on the product input typed by the user, to be used for some of the generated image ads;
7) generating a set of light colors relevant to the product input typed by the user and these colors are used for parts of the generated image ads; and
8) generating a set of dark colors relevant to the product input typed by the user. These colors will be used for parts of the generated image ads.

Thereafter the system is configured to take the uploaded product photo (image) with the changed background and turns it into several different layouts. Generated ad texts (Slogans, Descriptions, CTA, Review Message, Review Name, Question texts, Perks Bullet Points) are taken and placed on each image ad (i.e. each layout) in various permutations/variations, with the system randomizing each text's font.

In addition, each component (i.e. text, shape, fade, etc.) of each image ad/layout one of the generated dark colors and light colors to fit a contrasting theme. (i.e. it will put a text with a light color on a fade that has a dark color, or vice versa)

After the processing, the system presents all generated ads (all permutations of all layouts) to the user. Thereafter, the system generates sets of ad copy based on ad platforms that the user selects (i.e. if Facebook, Google and Instagram are selected, it will generate 5 Headlines and 5 Descriptions for Google Ads, 5 Primary Texts and 5 Headlines for Facebook ads, and 5 Short Captions and 5 Long Captions for Instagram).

### Flow 2: Creative Ad

In another embodiment, the system takes a user's initial input and generates questions in order to elicit from the user information to further understand the user's specific product, service, app or business.

The system then combines the user's answers to the generated questions along with the user's initial input for the user's product, service, app or business to generate image ad ideas/concepts.

The system uses AI algorithms to generate multiple images using the user's selected ad idea or ideas. The system uses an LLM (large Language Model) AI to generate ad texts relevant to all of the inputs typed by the user as well as the ad idea or ideas selected by the user.

Various configurations, utilize LLM AI to generate texts, bullet points and other materials relevant to advertisements. Examples are as follows:
a) The system is configured to use an LLM (large Language Model) AI to generate multiple Slogan/Headline texts relevant to all of the inputs typed by the user as well as the ad idea selected by the user. These slogans/headlines will be used for the generated image ads.
b) The system is configured to use an LLM (large Language Model) AI to generate multiple description texts relevant to all of the inputs typed by the user as well as the ad idea selected by the user. These descriptions will be used for the generated image ads.
c) The system is configured to use an LLM (large Language Model) AI to generate a CTA (call-to-action) text relevant to all of the inputs typed by the user as well as the ad idea selected by the user. Example: “Buy Now”. This will be used for the generated image ads.
d) The system is configured to use an LLM (large Language Model) AI to generate a review message text relevant to all of the inputs typed by the user as well as the ad idea selected by the user, along with a review name. These texts will be used for some of the generated image ads.
e) The system is configured to use an LLM (large Language Model) AI to generate multiple Question texts selling the inputs typed by the user in a way that is also relevant to the ad idea selected by the user. Example: “Want to look like a rock star?” for a brown leather jacket. This will be used for some of the generated image ads.
f) The system is configured to use an LLM (large Language Model) AI to generate a set of “bullet points” outlining the perks of the product relevant to all of the inputs typed by the user as well as the ad idea selected by the user. This will be used for some of the generated image ads.
g) The system is configured to use an LLM (large Language Model) AI to generate a set of light colors relevant to all of the inputs typed by the user as well as the ad idea selected by the user. These colors will be used for parts of the generated image ads.
h) The system is configured to use an LLM (large Language Model) AI to generate a set of dark colors relevant to all of the inputs typed by the user as well as the ad idea selected by the user. These colors will be used for parts of the generated image ads.

Thereafter, the system takes each of the images it generated from the user's selected ad ideas and turns each into a series of different layouts.

In another embodiment, the system takes generated ad texts (Slogans, Descriptions, CTA, Review Message, Review Name, Question texts, Perks Bullet Points) and places them on each image ad (i.e. each layout) in various permutations/variations.

The system may be capable of randomizing the font of each text.

The system makes each component (i.e. text, shape, fade, etc.) of each image ad/layout one of the generated dark colors and light colors capable of fitting a contrasting theme. (i.e. it will put a text with a light color on a fade that has a dark color, or vice versa)

In an operative mode, the system presents all generated ads (all permutations of all layouts) to user.

The system may be capable of generating sets of ad copy based on ad platforms that the user selects (e.g., if Facebook, Google and Instagram are selected, it will generate 5 Headlines and 5 Descriptions for Google Ads, 5 Primary Texts and 5 Headlines for Facebook ads, and 5 Short Captions and 5 Long Captions for Instagram).

### Flow 3: Ad Builder

In this embodiment the parameters of the “Creative Ad” system, described above, are utilized, but instead of the system generating ad ideas and images from that ad idea, the user just enters the ad idea to the system and then entered ad idea is used to generate images.

### Flow 4: Brand Profile

In this embodiment, a user inputs brand details, including but not limited to: brand icon, colors, fonts, name, description, sitelink/URL, media (i.e. images, videos and texts), etc. In addition the user inputs ad texts (i.e. headline, description, slogan, CTA text, etc. The user selects ad styles/settings (i.e. colors, icons, fonts, shapes, etc. ) and then ads are generated in either Flow 1 (Product Ad), Flow 2 (Creative Ad) or Flow 3 (Ad Builder) using the brand profile that the user set up. The generated ads are then be ‘branded’ using the user's uploaded branding (brand name, icon, colors, fonts, etc.)

### Flow 5: UGC Ads

In this embodiment a user inputs a link to the product, service or app (or skips the link in order to enter details manually)

In another embodiment media (e.g., images, videos, product name, product description, etc.) is automatically scraped from the input website (if the website has input media-otherwise the user is able to manually add the product details and media) and the user is further able to edit/add media.

In a still further embodiment the user is able to select or search for stock footage to be used in the ad, with the stock footage being fetched from a stock footage library. Alternatively or in addition, the user is also able to select or generate AI-generated footage (images, videos) to be used in the ad.

The user may also select video settings, such as the video ad size/dimensions (9:16, 1:1. 16:9), video ad duration, video ad language, video ad target language, etc.

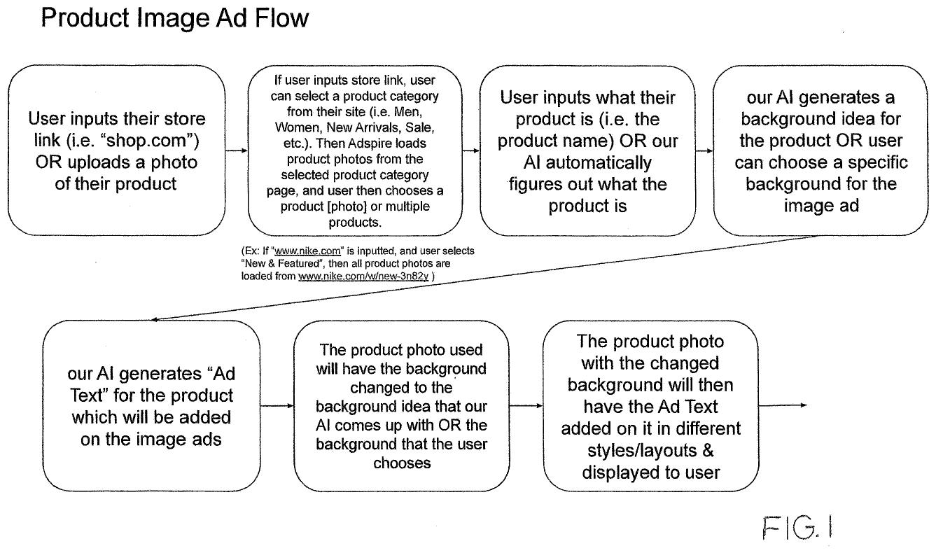

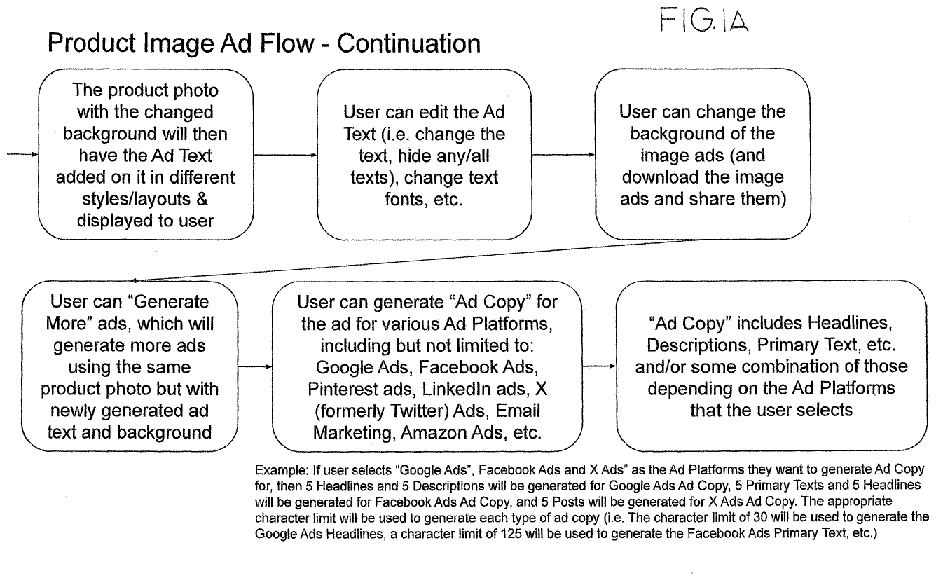

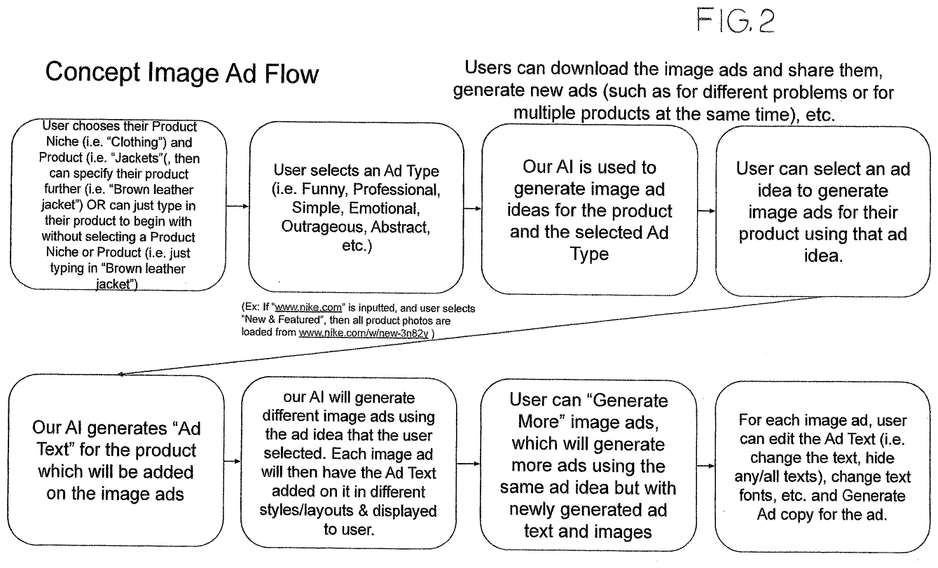

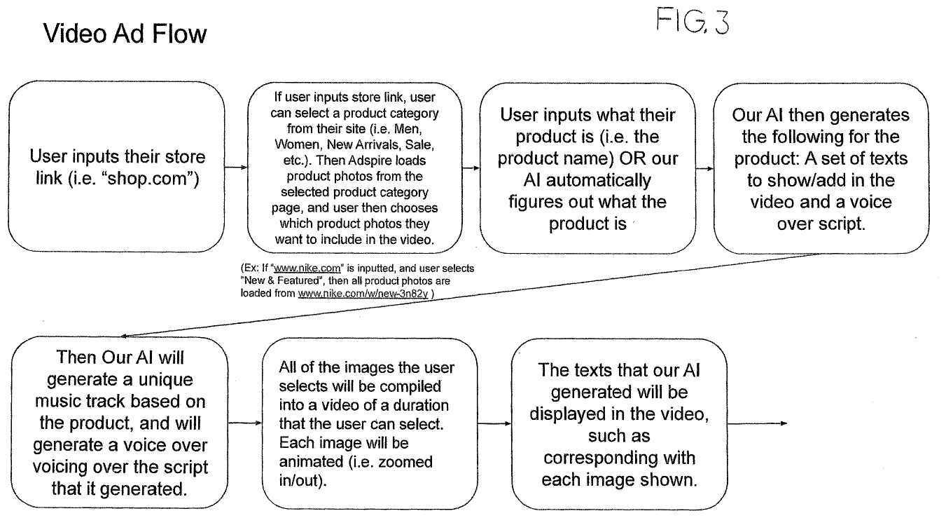

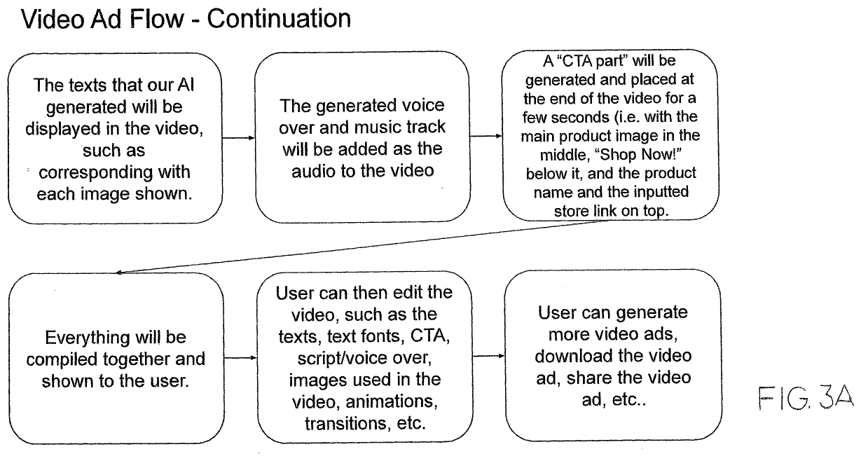

In other embodiments, AI is a free-standing format for generating image ad ideas for products and ad types with specific user input such as shown in FIG. 2. The AI is programmed to generate ad text and image ads with variations as it is programmed to be effective. FIGS. 3 and 3A illustrate how such programmed AI provides a video image ad flow and FIGS. 1 and 1A show a similar product image ad flow.

As described:
Flow 1: Product Ad—Generates 100+ image ads from an uploaded product photo
Flow 2: Creative Ad—Generates 100+ image ads+ad ideas from a description of a product, service, app or business
Flow 3: Ad Builder—Generates 100+ image ads from an ad idea/concept the user inputs.
Flow 4: Brand Profile—Generates 100+ image ads using user's brand details

Flow 5: UGC Ads—The term “UGC” refers to “User-generated content”, which is a person recording themself showcasing/promoting a product or service. This flow covers AI-generated UGC Ads, which are ads with human actors in them, lip syncing a voice over script generated by AI promoting the specified product or service.

In addition, Flow 6 relates to Commercial Ads—Wherein a video ad is generated by combining stock footage, AI-generated images/videos, uploaded media (images and/or videos), and an AI-generated voice over to form a ‘commercial video ad’.

In Flow 7 which comprises and Ad Autopilot—The system continuously monitors campaign and replaces underperforming ad creatives

EXAMPLES of the above flow elements as applied to specified products:

### Flow 1: Product Ad

### Product: Brown Leather Jacket

User Uploads Image: A user uploads a photo of a brown leather jacket on a mannequin with a busy retail background.
1. (Background Removal): In an initial step, the system automatically removes the retail background, leaving only the jacket with a transparent background.
2. (Polishing): The system then enhances the jacket's image by sharpening the details, adjusting the lighting, and making the leather shine to make it visually appealing.
3. (Generate Background Ideas): Based on the input “brown leather jacket,” the system generates relevant and related multiple background ideas for selection, such as:
   A rugged cityscape.
   A sleek, modern studio setting.
   A wooden, rustic background.
Should The user select the “rugged cityscape.” (and ad size, i.e. ‘Square’)
4. (AI Inserts Product in Scene): The system then places the jacket (with the transparent background) seamlessly into the “rugged cityscape” background, adjusting shadows and lighting to match the scene.
5. (Ad Text Generation): As a further extension of the ad generation, the system, using an LLM, generates ad copy text such as:
   “Feel the thrill of adventure in every stitch.”
6. (Slogan/Headline Generation): The system also generates headlines such as:
   “Own the Streets, in Style!”
   “Bold, Timeless, Unstoppable.”
7. (Description Generation): The system creates descriptions such as:
   “Crafted with premium leather, this brown jacket is designed for the modern man who values style and durability.”
8. (CTA Generation): The system suggests CTAs such as:
   “Get Yours Now!”
   “Shop the Collection Today.”
9. (Review Message and Name): The system generates a review text:
   “The quality is amazing, and the jacket fits perfectly. A must-have for any wardrobe!”—John D.
10. (Question Texts): It creates questions like:
   “Want to look like a rockstar?”
   “Need a jacket that matches your bold personality?”
11. (Perks Bullet Points): The system generates perks such as:
   “Premium leather material”
   “Classic, versatile design”
   “Durable for everyday wear”
12. (Light and Dark Colors): Based on the product, the system selects color palettes such as:
   Light Colors: Beige, Off-white
   Dark Colors: Deep Brown, Charcoal Grey
13. (Ad Layout Generation): The system generates several layouts, where the jacket is featured in different positions (center, side) with various background placements.
14. (Text Placement): The system applies permutations of the slogans, descriptions, CTAs, and review texts across the different layouts, placing text in various positions.
15. (Font Randomization): Fonts are randomized for each text element, trying bold, serif, and modern fonts.
16. (Color Contrasting): The system ensures that each component fits a contrasting theme, such as by placing light-colored text on a dark background fade or vice versa.
17. (Presenting Ads to User): The system presents the user with all generated ad options, showing different combinations of backgrounds, layouts, and text arrangements.
18. (Platform-Specific Ad Copy): The system asks which platforms the user wants to advertise on (Facebook, Instagram, Google) and generates specific copy:
   For Facebook: “Be unstoppable. This jacket has it all.” (Primary Text)
   For Instagram: “Timeless, bold, stylish. #jackets #trendyproducts #leather” (Short Caption)
   For Google: “Shop the boldest leather jacket now.” (Headline)

The user then selects a preferred ad version and proceeds to use it for an ad campaign.

### Flow 2: Creative Ad

### Product: Mobile App for Fitness Tracking

User's Initial Input: The user inputs that the user is creating an ad for a fitness tracking app that helps clients set workout goals, track their progress, and offers personalized workout plans.
1. (Generate Questions): The system generates questions such as:
   “Who is your target audience?”
   “What specific features of your app do you want to highlight?”
   “What type of imagery best represents your brand (e.g., active, minimalist, modern)?”
   “Do you have a specific theme or tone in mind for your ad (e.g., motivational, fun, serious)?”
2. User Answers (Exemplified):
   Target audience: Fitness enthusiasts ages 18-40.
   Highlight features: Personalized workout plans, progress tracking, and social sharing.
   Preferred imagery: Active, dynamic visuals of people working out.
   Tone: Motivational.
3. (Generate Ad Ideas/Concepts): By using the initial input and user answers, the system generates several ad concepts such as:
   Concept 1: “Push Your Limits”—Dynamic shots of people lifting weights and running.
   Concept 2: “Track Every Victory”—Focus on progress charts and app screens.
   Concept 3: “Your Personal Fitness Coach”—Emphasizing personalized workout plans.
4. Assuming that the user selects Concept 1: “Push Your Limits” (and ad size, i.e. ‘Square’):
5. The system generates several images featuring individuals in different workout environments (gym, park, home), pushing their limits. Each image has a dynamic, high-energy feel.
6. (Generate Ad Texts): The system, using an LLM, generates ad copy texts based on the user's inputs and selected ad idea:
   “Achieve your goals with personalized workout plans.”
   “Track every step, every lift, every progress.”
7. (Generate Slogans/Headlines): The system creates slogans/headlines such as:
   “Push Your Limits!”
   “Crush Your Fitness Goals.”
   8. (Generate Descriptions): The system generates descriptions such as:
“Our fitness tracking app gives you the tools to set and smash your workout goals. Create personalized plans and track your progress, all in one place.”
9. (Generate CTA): The system suggests CTAs such as:
   “Download Now!”
   “Start Your Journey Today.”
10. (Generate Review Message & Name): The system generates a review text and name:
   “This app completely transformed my workout routine. I'm hitting goals I never thought possible!”—Sarah M.
11. (Generate Question Texts): The system creates questions such as:
   “Ready to crush your fitness goals?”
   “Want to track every rep and step?”
12. (Generate Perks Bullet Points): It outlines perks:
   “Personalized workout plans.”
   “Real-time progress tracking.”
   “Social sharing with your fitness community.”
13. (Generate Light and Dark Colors): Based on the active, motivational theme, the system selects:
   Light Colors: Neon Yellow, Sky Blue.
   Dark Colors: Deep Black, Charcoal Grey.
14. (Ad Layout Generation): The system generates different layouts, such as:
   Image-centered with text at the bottom.
   Split screen with the product on one side and the text on the other.
15. (Text Placement): The system applies variations of slogans, descriptions, CTAs, review messages, and perks bullet points across different layouts.
16. (Font Randomization): Th system randomizes fonts for each text element, using bold, modern fonts for the headlines and sleek, minimalistic fonts for the descriptions.
17. (Contrasting Theme): The system ensures contrast between the text and background by using light-colored fonts (Neon Yellow, Sky Blue) on darker parts of the background and vice versa.
18. (Presenting Ads to User): The system presents all ad versions to the user, showing a wide variety of layouts, colors, and text combinations to choose from.
19. (Platform-Specific Ad Copy): The system generates ad copy for specific platforms:
   Facebook: “Crush your fitness goals with personalized workout plans! Download today and start your fitness journey.” (Primary Text)
   Instagram: “Track every step, every rep. Start now!” (Short Caption)
   Google: “Get the ultimate fitness app to track your workouts.” (Headline)

The user reviews and selects a preferred ad and copy for the ad campaign.

### Flow 3: Ad Builder

The exact same procedural steps are included as in “Creative Ad” flow, but instead of the system generating ad ideas and images from that ad idea, the user just enters the ad idea. Then that ad idea the user enters is used to generate images.

### Product: Leather Jacket

### Example:

In this embodiment, the user types “a penguin wearing a leather jacket in front of a sunset”

Then the user selects Ad Type (i.e. ‘Funny’, or ‘Unique’)

The user then selects Ad Settings (i.e. Ad Size and Ad Language)

(Generate Images): Based on the user's typed ad idea, the system generates several image options featuring visuals of a penguin wearing a leather jacket in front of a sunset.

From here on in, the flow follows the same steps as in the Creative Ad process. The system generates ad texts, slogans, descriptions, CTAs, and review messages, all based on the user's input and ad idea. The system then generates ad layouts and variations, using light and dark color themes to ensure contrast and dynamic presentation.

### Flow 4: Brand Profile

### Brand: Urban Pulse Sneakers

1. (User Inputs Brand Details):
The user creates a brand profile for a sneaker company, Urban Pulse, by entering:
   Brand Icon: A stylized sneaker logo.
   Colors: Neon green and charcoal black.
   Fonts: Bold, modern sans-serif fonts.
   Name: Urban Pulse Sneakers.
   Description: “Urban Pulse Sneakers: Where comfort meets street style.”
   URL: www.urbanpulsesneakers.com.
   Media: Uploads a promotional video of people wearing the sneakers and several product images of the shoes from different angles.
2. (User Inputs Ad Texts):
   Headline: “Step into the Pulse of the City.”
   Description: “Sleek design, unmatched comfort. Urban Pulse Sneakers are built for the urban explorer.”
   Slogan: “Feel the Pulse.”
   CTA Text: “Shop Now.”
3. (User Selects Ad Styles/Settings):
   The user selects ad styles such as:
      Shape: Modern geometric shapes.
      Colors: Keeps neon green and charcoal black from the brand palette.
      Icons: Sleek, minimalist icons.
4. (Generate Ads Using Brand Profile):
The user chooses to generate ads through Flow 2 (Creative Ad). The system uses the Urban Pulse brand profile to create multiple ad variations, with the brand colors, fonts, and logo integrated into each layout. The ads feature the slogan “Feel the Pulse” overlaid on dynamic sneaker images, with the CTA “Shop Now” highlighted in neon green, ensuring the brand identity is consistent across all generated ads.

### Flow 5: UGC Ads

### Product: Wireless Bluetooth Earbuds

1. (User Inputs Product Link or Details):
The user inputs a link to a product page for Wireless Bluetooth Earbuds.
2. (Automatic Scraping & User Editing):
The system automatically scrapes the product page and retrieves:
   Product name: “Noise-Canceling Bluetooth Earbuds”
   Description: “High-quality wireless earbuds with active noise cancelation and up to 24-hour battery life.”
   Media: Images of the earbuds, a video showing them in use, and promotional copy from the product page.
3. The user reviews the scraped media and decides to upload an additional product photo and change the description to:
“Ultra-lightweight Bluetooth earbuds with superior sound, noise cancelation, and 24-hour battery.”
4. (Select Stock Footage):
The user searches for stock footage of people jogging while wearing wireless earbuds and adds it to the ad.
5. Select AI-Generated Footage):
The user also selects AI-generated footage of a 3D rendering of the earbuds rotating to showcase the design.
6. (Select Video Settings):
The user selects:
   Ad size: 9:16 (vertical) for TikTok ads.
   Duration: 30 seconds.
   Language: English.
   Target language: Spanish (the system will auto-translate captions).
7. (Generate Video Ad Script):
The system uses the media and product details to generate a script. It starts with: “Tired of tangled cords? Our noise-canceling Bluetooth earbuds are the perfect solution for your on-the-go lifestyle.”
8. (Edit/Select Script & Hooks):
The user edits the script to include a stronger hook:
“Want studio-quality sound in your pocket? These noise-canceling Bluetooth earbuds are your go-to!”
They also add a second hook to generate an alternate version:
“Say goodbye to wires—experience freedom with noise-canceling Bluetooth earbuds!”
9. (Select Visual Style):
The user selects “quick transitions” as the video style to give the ad a fast-paced, energetic feel.
10. (Select Avatar):
The user selects a realistic, AI-generated avatar of a young fitness influencer wearing the earbuds.
11. (Edit Music, Voice, Captions, etc.):
The user selects a high-energy electronic music track and a female voiceover. The user chooses bold, animated captions with contrasting colors.
12. (Video Generation):
The system generates the video ad, combining the selected footage, AI avatar, music, voice, and captions.
13. (Ad Presentation):
The user reviews the generated ad, making a final tweak to the ending caption to say “Shop Now!” instead of “Get Yours Today!”
14. (Publish or Download):
The user chooses to publish the ad directly to the user's TikTok Ads account, selecting an existing campaign. The user also downloads a copy for future use.

In this flow, the user is guided through a dynamic, AI-enhanced process of building a UGC-style video ad using the product's details and media, along with AI-generated assets.

### Flow 6: Commercial Ads

Product: Luxury Skincare Serum

User Uploads Product Photo and/or Other Media

The user uploads a photo of the luxury skincare serum, along with additional media such as a short product description, a video showcasing the product's smooth texture, and a link to the product's landing page.

### AI Modifies the Product Photo/Media

The AI adjusts the uploaded product photo, changing the background to a high-end spa setting with serene lighting and adds a text overlay: “Reveal Your Glow”.

### Stock Footage Selection

The user browses a stock footage library and selects a clip of a model applying skincare serum in a lush bathroom setting, enhancing the luxury feel of the ad.

### AI-Generated Footage

The user also generates AI footage of a close-up drop of serum landing on smooth skin, highlighting the product's texture and effect.

### User Selects and Settings

The user selects an ad duration of 15 seconds, with dimensions 9:16 for a vertical Instagram Story ad, and an ad type that's professionally polished, highlighting luxury and elegance.

### AI Generates Video and Scripts

The system uses the product details and ad settings to generate a script:

“Unlock the secret to radiant, youthful skin with our luxury skincare serum. Crafted with the finest ingredients for a flawless complexion. Buy yours today.”

### User Edits/Selects Music, Voice, and Captions

The user chooses a soft, relaxing piano track for background music, a soothing female voice for the voiceover, and sets the captions to appear in a subtle, stylish font.

### User Selects Visual Style

The user opts for an over-cards visual style, with smooth transitions between scenes and text appearing over the product images in a clean, modern design.

### User Edits the Scenes

The user arranges the scenes, starting with the AI-generated close-up footage, transitioning into the stock footage of the model applying the serum, and ending with the product photo in the spa setting with the CTA: “Shop Now for Luxurious Skin”.

### Video and Generation

The system generates the complete video ad in the backend, ready for preview on the home screen.

### Ad Presentation

The user can now download the ad or publish it directly to platforms such as Instagram, Facebook, or Google Ads.

### Ad Publishing Options

If the user chooses to publish the ad, the user can select an existing ad campaign on Facebook or create a new campaign within the system.

### Flow 7: Ad Autopilot

### Product: Brown Leather Jacket

1. System monitors user's linked ad account
The system monitors the user's linked Facebook Ads account every 3 days to track the performance of the current ad campaign promoting the brown leather jacket.
2. System checks KPIs against user-set thresholds
The user has set thresholds for key performance indicators (KPI): CTR (click through rate) must be above 2%, CPC (cost per click) below $1.50, and ROAS (return on ad spent) at least 4:1. After 3 days, the system finds that the CTR has dropped to 1.5%.
3. System deems the ad as ‘underperforming’ and replaces it
Since the CTR is below the set threshold, the system flags the current ad as underperforming. It decides to generate a new ad using the UGC video ad flow to create a more relatable, engaging campaign.
   New Ad Generation Steps:
      User uploads fresh media or selects existing ones, such as customer photos wearing the brown leather jacket.
      The system scrapes reviews or testimonials to include in the new ad.
      It generates a video script highlighting user experiences and showcases the jacket in various settings.
      The ad features upbeat music and a catchy voiceover.

### 4. Repeat

After generating and launching the new UGC video ad, the system continues to monitor the performance every 3 days. If the new ad achieves the desired KPIs, it stays live; if not, the process repeats to ensure optimal ad performance.

This example illustrates how the Ad Autopilot flow can be applied to a specific product campaign, continuously optimizing based on performance metrics.

It is understood that the above descriptions and examples are merely illustrative and that changes may be made in terms of input, processing and use of an ad pilot for monitoring of ad effect, including elimination or changes of specific processes, without departing from the scope of the invention as defined in the following claims.

What is claimed is:

1. A system for the production of advertisements comprising:
i. a product input comprising at least one of:
a. a product image and product description,
b. product image with product description and system generated questions to elicit information about the product,
c. user input advertisement ideas and images,
d. existing brand details,
e. user input of a link to existing product, service or app, and
f. user uploads photograph or other media showing product;
ii. a processing procedure of the input configured with at least one of:
a. isolating and polishing an input product image and generating relevant background ideas for user selection, then using AI to insert the product into separate multiple, relevant backgrounds, with audio, video or print advertisement text, with multiple user selectable options of audio, video or print appearances and combinations, with optional relevance to a proposed platform for the advertisements;
b. generating questions relevant to an input product and using answers to target a relevant advertisement audience with appropriate features and imagery and generating multiple advertisement texts and layouts, with optional relevance to a proposed platform the advertisements;
c. direct user entry of advertisement ideas and images with generation of advertisements with appropriate features and imagery and generating multiple advertisement texts and layouts, with optional relevance to a proposed platform the advertisements;
d. direct user entry of brand details and ad texts with ad styles and/or settings with the system generating advertisements with brand details and selected ad styles and/or settings;
e. direct user input of internet links to product or direct entry of product details with system scraping of product page details with retrieval or product type, description and media or video images for user review and editing with user selection of stock or AI generated footage for selected addition and user selection of video setting and ad script and selected relevant additions;
f. direct user uploading of media showing a product and stock footage related to product with AI modifying the media and generating relevant footage and ad script to generate video ad editable by user;
iii. optionally providing an ad autopilot which monitors a user's linked ad account, checks key performance indicators against user-set thresholds with ads underperforming relative to the thresholds being replaced by other ads.

2. The system for production of advertisements of claim 1, wherein:
i. a product media image is configured to be input to the system wherein background is removed so that only the product media image, is visible and the background becomes transparent;
ii. the system is configured to generate background ideas relevant to the product image wherein a user is enabled to select one of these background ideas, and whereby AI algorithm software is enabled to be used to put the visible product image into the background idea selected by the user;
iii. Large Language Model (LLM) AI is configured to perform any or all of the following generating actions with respect to the selected product image with background ideas:
a) generation of ad texts relevant to the selected product image product input with the LLM generating relevant multiple Slogan/Headline texts relevant for generated image ads;
b) generation of multiple description texts relevant to the selected product image product input, with these descriptions being used for generated image ads;
c) generation of a CTA (call-to-action) text relevant to the selected product image product input;
d) generation of a review message text relevant to selected product image product input, along with a review name, with these texts configured to be used for at least one of generated image ads;
e) generation of multiple question texts selling the product, based on the selected product image product input to be used for at least one of the generated image ads;
f) generation of a set of “bullet points” outlining the perks of the selected product image product input, to be used for at least one of the generated image ads;
g) generation of a set of light colors and of dark colors relevant to the selected product image product input wherein and the light and dark colors are used for at least of the generated image ads; and
wherein the system is configured to take any or all of generated texts and images to generate ads for the user to select for use.

3. The system for production of advertisements of claim 2, wherein the system generates ads configured to be appropriate for different ad platforms for user selection.

4. The system for production of advertisements of claim 1, wherein:
a. the system is configured to takes a user's input to generate questions to elicit input information answers for further understanding the user's specific product, service, app or business;
b. the system is configured to combine the user's answers to the generated questions together with the user's initial input for the user's product, service, app or business to generate image ad ideas;
c. The system is configured to use AI algorithms to generate multiple images using the user's selected ad idea or ideas and wherein the system is configured to use an LLM AI to generate ad texts relevant to all of the inputs of the user as well as the ad idea or ideas selected by the user.

5. The system for production of advertisements of claim 4, wherein the LLM AI is configured to generate texts, bullet points and other materials relevant to advertisements.

6. The system for production of advertisements of claim 5, wherein the system is configured to use the LLM AI to generate multiple Slogan/Headline texts relevant to all of the inputs and ad ideas selected by the user for used in generated image ads, and wherein the system is further configured to use an LLM AI to generate multiple description texts relevant to inputs and ad ideas selected by the user for use in generated image ads.

7. The system for production of advertisements of claim 6, wherein the system is configured to use the LLM AI to generate a CTA (call-to-action) text relevant to inputs and ad ideas selected by the user and is further configured to use the LLM (Large Language Model) AI to generate a review message text relevant to inputs and ad ideas selected by the user, along with a review name for use in at least one of generated image ads.

8. The system for production of advertisements of claim 7, wherein the system is configured to use the LLM AI to generate multiple question texts selling inputs in a manner that is also relevant to ad ideas selected by the user. for use for at least one of generated image ads and wherein the system is further configured to use the LLM AI to generate a set of “bullet points” outlining the perks of the product relevant to inputs and ad idea selected by the user for used in at least one of generated image ads.

9. The system for production of advertisements of claim 8 wherein the system is configured to use the LLM AI to generate a set of light colors and a set of dark colors relevant to relevant to inputs and ad ideas selected by the user for use for parts of generated image ads.

10. The system for production of advertisements of claim 1, wherein the system is configured to take images it generated from the user's selected ad ideas and to turn them into a series of different ad layouts.

11. The system for production of advertisements of claim 1, wherein the system is configured such that when the user enters an ad idea to the system the entered ad idea is used to generate images.

12. The system for production of advertisements of claim 1, wherein the system is configured such that when a user inputs a brand profile with brand details, ads are generated using the brand profile.

13. The system for production of advertisements of claim 1, wherein the system is configured to enable a user to provide input either manually or with a link to a website or app with product or service information, wherein media is automatically scraped from the input website or app or the user is able to manually add the product details and media and wherein the user is further able to edit or add media.

14. A method for the production of advertisements for products or services with the system of claim 1, comprising the steps of:
i. providing a product-input to the system, comprising at least one of:
a) a product image and product description,
b) a product image with product description and system generated questions to elicit information about the product,
c) user input advertisement ideas and images,
d) existing brand details,
e) user input of a link to existing product, service or app, anduser uploads photograph or other media showing product;
ii. processing of the input with at least one of:
isolating and polishing an input product image and generating relevant background ideas for user selection, then using AI to insert the product into separate multiple, relevant backgrounds, with audio, video or print advertisement text, with multiple user selectable options of audio, video or print appearances and combinations, with optional relevance to a proposed platform for the advertisements;
2. generating questions relevant to an input product and using answers to target a relevant advertisement audience with appropriate features and imagery and generating multiple advertisement texts and layouts, with optional relevance to a proposed platform for the advertisements;
3. direct user entry of advertisement ideas and images with generation of advertisements with appropriate features and imagery and generating multiple advertisement texts and layouts, with optional relevance to a proposed platform for the advertisements;
4. direct user entry of brand details and ad texts with ad styles and/or settings with the system generating advertisements with brand details and selected ad styles and/or settings:
5. direct user input of internet links to product or direct entry of product details with system scraping of product page details with retrieval or product type, description and media or video images for user review and editing with user selection of stock or AI generated footage for selected addition and user selection of video setting and ad script and selected relevant additions;
6. direct user uploading of media showing a product and stock footage related to the product with AI modifying the media and generating relevant footage and ad script to generate video ad editable by user.

15. The method of claim 14, wherein a further step comprises providing an ad autopilot which monitors a user's linked ad account, checks key performance indicators against user-set thresholds with ads underperforming relative to the thresholds being replaced by other ads.
